(19) United States
(12) Patent Application Publication
(10) Pub. No.: US 2023/0135779 A1
(43) Pub. Date: May 4, 2023

(54) BICYCLE HANDLEBAR FOR A CONTROL DEVICE

(71) Applicant: SRAM, LLC, Chicago, IL (US)

(72) Inventors: Pierre KOMMER, Schweinfurt (DE); Nathan SCHICKEL, Indianapolis, IN (US); Ming CHANG, Taichung City (TW); En-Chieh CHEN, Taichung City (TW)

(73) Assignee: SRAM, LLC, Chicago, IL (US)

(21) Appl. No.: 17/972,040

(22) Filed: Oct. 24, 2022

Related U.S. Application Data
(60) Provisional application No. 63/272,793, filed on Oct. 28, 2021.

(51) Int. Cl. B62K 21/12; B62K 23/02

(52) U.S. Cl. CPC B62K 21/12; B62K 23/02

(57) ABSTRACT

A bicycle handlebar includes a handlebar body and a recessed structure. The handlebar body has an outer surface. The recessed structure is recessed from the outer surface of the handlebar body, and has a mounting surface that is indented from the outer surface of the handlebar body and that is adapted for a control device to be mounted thereto.

This application claims the benefit of U.S. Provisional Application Ser. No. 63/272,793 filed Oct. 28, 2021, which is referenced herein in its entirety.

### FIELD

The disclosure relates to a bicycle handlebar, and more particularly to a bicycle handlebar mounted with a control device.

### BACKGROUND

Hand-actuated control devices may be mounted to a handlebar of a bicycle for controlling various types of mechanical or electromechanical components of the bicycle. Conventionally, the control devices may need additional brackets or holders to be attached to the handlebar. The attached control devices may generate raising surfaces on the handlebar, rendering the overall appearance of an assembly of the handlebar and the control devices unsmooth. In addition to visual defect, the unsmooth profile of the assembly of the handlebar and the control devices may be adverse to the bicycle in terms of aerodynamics.

### SUMMARY

Therefore, an object of the disclosure is to provide a bicycle handlebar that can alleviate at least one of the drawbacks of the prior art.

According to an example of the disclosure, the bicycle handlebar includes a handlebar body and a recessed structure. The handlebar body has an outer surface. The recessed structure is recessed from the outer surface of the handlebar body, and has a mounting surface that is indented from the outer surface of the handlebar body and that is adapted for a control device to be mounted thereto.

According to another example of the disclosure, the bicycle handlebar assembly includes a handlebar body, a recessed structure and a control device. The handlebar body has an outer surface. The recessed structure is recessed from the outer surface of the handlebar body, and has a mounting surface that is indented from the outer surface of the handlebar body. The control device is mounted to the mounting surface.

### BRIEF DESCRIPTION OF THE DRAWINGS

Other features and advantages of the disclosure will become apparent in the following detailed description of the embodiments with reference to the accompanying drawings, of which:

FIG. 1 is a side view illustrating a bicycle;

FIG. 2 is an exploded perspective view illustrating a bicycle handlebar;

FIG. 3 is a top view illustrating the bicycle handlebar;

FIG. 4 is a front view illustrating the bicycle handlebar;

FIG. 5 is a side view illustrating the bicycle handlebar;

FIG. 6 is a fragmentary side view illustrating the bicycle handlebar;

FIG. 7 is a fragmentary front view illustrating the bicycle handlebar;

FIG. 8 is a fragmentary side view illustrating the bicycle handlebar mounted with a control device;

FIG. 9 is a front view illustrating another example of the bicycle handlebar;

FIG. 10 is a bottom view illustrating the bicycle handlebar in FIG. 9;

FIG. 11 is a fragmentary side view illustrating the bicycle handlebar in FIG. 9;

FIG. 12 is partly exploded perspective view illustrating still another example of the bicycle handlebar;

FIG. 13 is a fragmentary, partly exploded perspective view illustrating the bicycle handlebar in FIG. 12;

FIG. 14 is a perspective view illustrating still another example of the bicycle handlebar;

FIG. 15 is a fragmentary perspective view illustrating the bicycle handlebar in FIG. 14;

FIG. 16 is a perspective view illustrating still another example of the bicycle handlebar; and

FIG. 17 is a fragmentary perspective view illustrating the bicycle handlebar in FIG. 16.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

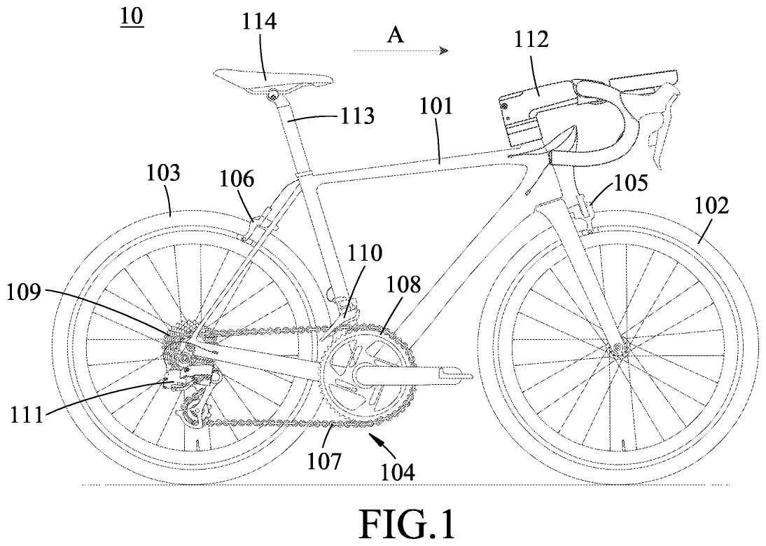

FIG. 1 generally illustrates a bicycle 10 in which the bicycle handlebar according to the disclosure is used. The bicycle 10 includes a main frame 101, a front wheel 102, a rear wheel 103 and a drivetrain 104. The front wheel 102 and the rear wheel 103 are rotatably connected to the main frame 101. The drivetrain 104 includes a chain 107, a front sprocket assembly 108 rotatably mounted to the main frame 101, and a rear sprocket assembly 109 coaxially mounted to the rear wheel 103. Each of the front sprocket assembly 108 and the rear sprocket assembly 109 includes at least one chainring. The bicycle 10 further includes a braking system that includes a front brake 105 and a rear brake 106 for respectively braking the front wheel 102 and the rear wheel 103. The bicycle 10 may further include a shifting system that includes a front derailleur 110 and a rear derailleur 111 for moving the chain 107 respectively on the front sprocket assembly 108 and the rear sprocket assembly 109. The braking system and the shifting system may be mechanically controlled or non-mechanically controlled. The bicycle 10 further includes a stem 112 that is rotatably mounted to the main frame 101. The bicycle handlebar is attached to the stem 112. The bicycle 10 further includes a seat post 113 that supports a saddle 114. The direction of arrow “A” in FIG. 1 indicates a forward direction of movement for the bicycle 10.

In FIG. 1, the bicycle 10 is illustrated as a road bike. However, the bicycle handlebar according to the disclosure has applications to any kind of bicycles with/without a suspension system, and/or with a single-speed drivetrain or a multi-speed drivetrain.

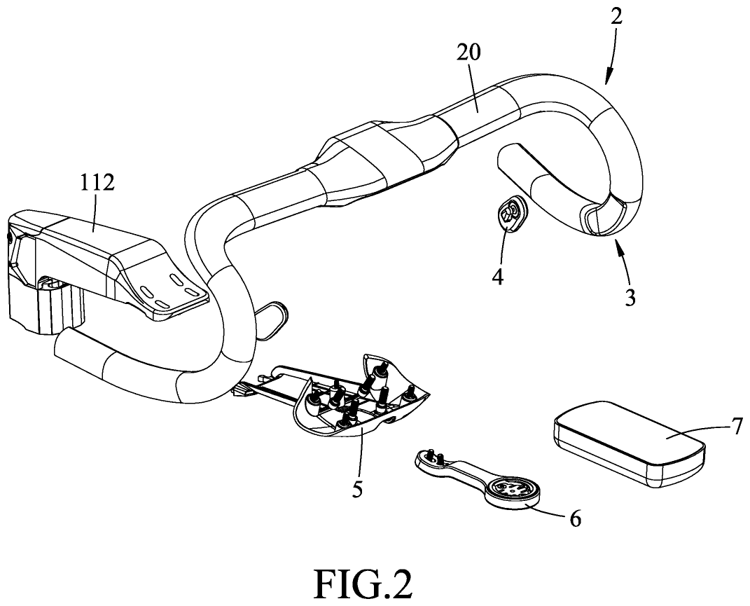

Referring to FIG. 2, the bicycle handlebar is for being mounted with at least one control device 4, and includes a handlebar body 2 and at least a recessed structure 3. The handlebar body 2 has an outer surface 20. The recessed structure 3 is recessed from the outer surface 20 of the handlebar body 2. The control device may be configured to control the gear shifting of the front derailleur 110 and the rear derailleur 111 or the suspension system of the bicycle. The control device may also be configured to control the position of the seat post 113, to control paring with other electronic components, or to control operational mode of the bicycle.

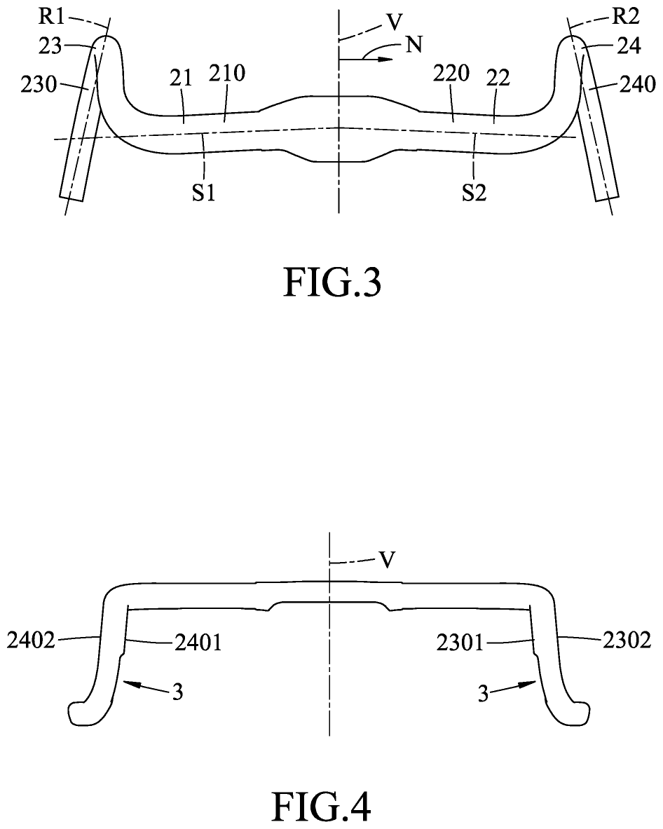

Referring further to FIGS. 3 and 4, the bicycle handlebar may be configured as a drop-type handlebar. For example, the handlebar body 2 has a left straight portion 21, a right straight portions 22, a left drop portion 23 and a right drop portion 24.

In one embodiment shown in FIG. 3, the left and right straight portions 21, 22 are respectively located at two opposite sides of a longitudinal vertical plane (V) that extends in the longitudinal direction of the bicycle 10 and that has a normal vector (N) extending in a left-right direction. The left drop portion 23 is connected to a leftmost end of the left straight portion 21 that is distal from the right straight portion 22. The left drop portion 23 may curl downwardly and extend rearwardly. The right drop portion 24 is connected to a rightmost end of the right straight portion 22 that is distal from the left straight portion 21. The right drop portion 24 may curl downwardly and extend rearwardly. Each of the left and right straight portions 21, 22 has an outer surface portion 210, 220 that serves as a portion of the outer surface 20 of the handlebar body 2. Each of the left and right drop portions 23, 24 has an outer surface portion 230, 240 that serves as a portion of the outer surface 20 of the handlebar body 2. The recessed structure 3 may be recessed from the outer surface portion 210, 220, 230, 240 of one of the left straight portions 21, the right straight portions 22, the left drop portion 23 and right drop portion 24 of the handlebar body 2.

Specifically, in FIG. 4, the outer surface portion 230 of the left drop portion 23 has an inboard surface portion 2301 facing the right drop portion 24, and an outboard surface portion 2302 facing away from the right drop portion 24. The outer surface portion 240 of the right drop portion 24 has an inboard surface portion 2401 facing the left drop portion 23, and an outboard surface portion 2402 facing away from the left drop portion 23. The recessed structure 3 may be recessed from the inboard surface portion 2301, 2401 or the outboard surface portion 2302, 2402 of one of the left and right drop portions 23, 24.

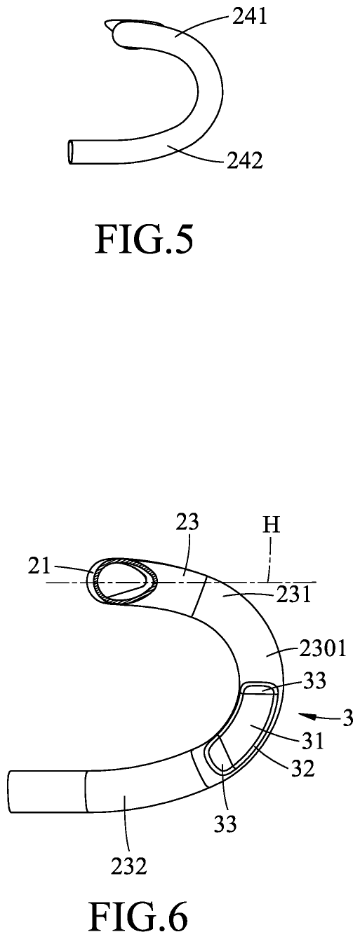

Referring further to FIGS. 5 and 6, in one embodiment, each of the left and right drop portions 23, 24 has an upper portion 231, 241 curling downwardly from the respective one of the left and right straight portions 21, 22, and a lower portion 232, 242 extending rearwardly from the upper portion 231, 241. With further reference to FIG. 3, a first reference plane (R1) in which the lower portion 232 of the left drop portion 23 resides may be oblique to the longitudinal vertical plane (V). A second reference plane (R2) in which the lower portion 242 of the right drop portion 24 resides may be oblique to the longitudinal vertical plane (V). In one embodiment, the left straight portions 21 may extend along a first axis (S1) that is oblique to the normal vector (N) of the longitudinal vertical plane (V). The right straight portions 22 may extend along a second axis (S2) that is oblique to the normal vector (N) of the longitudinal vertical plane (V).

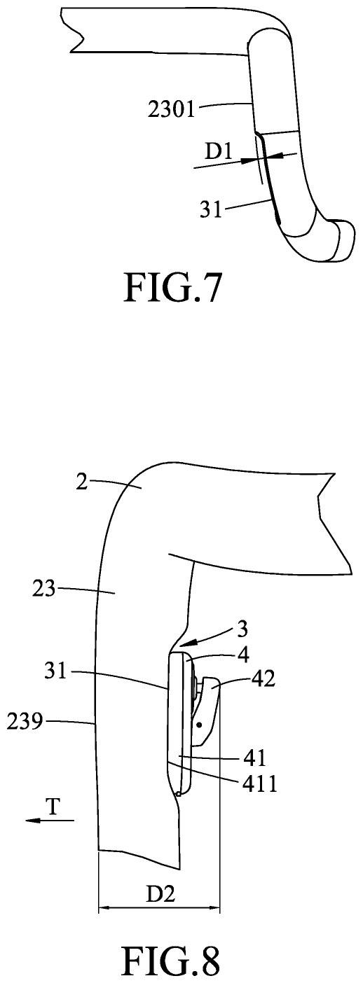

Referring to FIGS. 6 and 7, in one embodiment, the recessed structure 3 is formed in the inboard surface portion 2301 of the left drop portion 23, and has a mounting surface 31 that is indented from the inboard surface portion 2301 of the left drop portion 23 and that is for a control device to be mounted thereto. In one embodiment, a maximum offset distance (D1, see FIG. 7) between the mounting surface 31 and the inboard surface portion 2301 of the left drop portion 23 ranges from 1 to 5 millimeters. In one embodiment, the recessed structure 3 is spaced apart from a horizontal plane (H) in which the left straight portion 21 resides. In one embodiment, the mounting surface 31 of the recessed structure 3 extends along the left drop portion 23 of the handlebar body 2.

In one embodiment, the recessed structure 3 further has a transition zone between the mounting surface 31 and the inboard surface portion 2301 of the left drop portion 23. For example, the recessed structure 3 has a transition zone 32 that surrounds the mounting surface 31. In one embodiment, the transition zone 32 may be configured as a rounded edge. In one embodiment, the inboard surface portion 2301 of the left drop portion 23 may be configured as a curved surface, and the radius of curvature of the transition zone 32 is smaller than the radius of curvature of the inboard surface portion 2301 of the left drop portion 23.

In one embodiment, the recessed structure further has two curved surfaces. For example, the recessed structure 3 further has two curved surfaces 33 respectively connected to two opposite ends of the mounting surface 31. An assembled surface consisting of the mounting surface 31 and the curved surfaces 33 is smooth.

Referring further to FIG. 8, in one embodiment, the control device may be an electronic control device. For example, the control device 4 includes a casing 41, and a press lever or pushbutton 42 mounted to the casing 41. The casing 41 has a mounting surface 411 that is mounted to the mounting surface 31 of the recessed structure 3 and that is distal from the pushbutton 42. The left drop portion 23 of the handlebar body 2 has a distal portion 239 that is opposite the control device 4 in a transverse direction (T) perpendicular to the extending direction of the left drop portion 23 of the handlebar body 2. A distance (D2) between the distal portion 239 of the handlebar body 2 and a distal end of the pushbutton 42 that is distal from the mounting surface 411 ranges from 20 to 50 millimeters. As such, the control device 4 can be operated with minimized physical effort and discomfort.

In one embodiment, an extent of the mounting surface 31 of the recessed structure 3 is larger than a dimension of the casing 41 of the control device 4. As such, the location of the control device 4 on the mounting surface 31 is adjustable for ergonomic consideration. In one embodiment, the mounting surface 31 is configured as a planar surface.

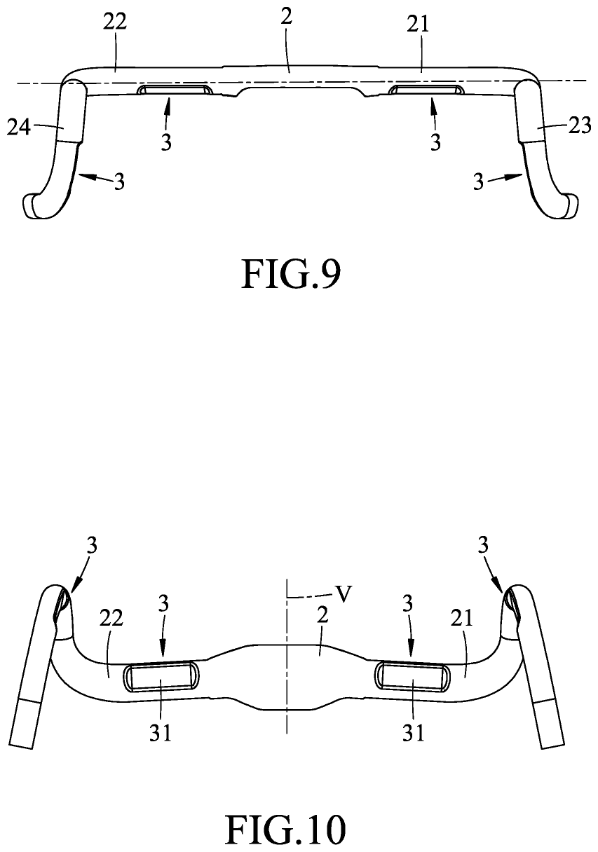

Referring to FIGS. 9 and 10, in one embodiment, the bicycle handlebar may includes a plurality of recessed structures formed in the handlebar body 2 for respectively mounted with a plurality of control devices. For example, the bicycle handlebar includes a plurality of recessed structures 3 respectively formed in the left straight portions 21, the right straight portions 22, the left drop portion 23 and right drop portion 24 of the handlebar body 2. In one embodiment, the recessed structures 3 are spaced apart from the longitudinal vertical plane (V). In one embodiment, the mounting surface 31 of the recessed structure 3 that is formed in the left straight portions 21 extends along the left straight portions 21. The mounting surface 31 of the recessed structure 3 that is formed in the right straight portions 22 extends along the right straight portions 22.

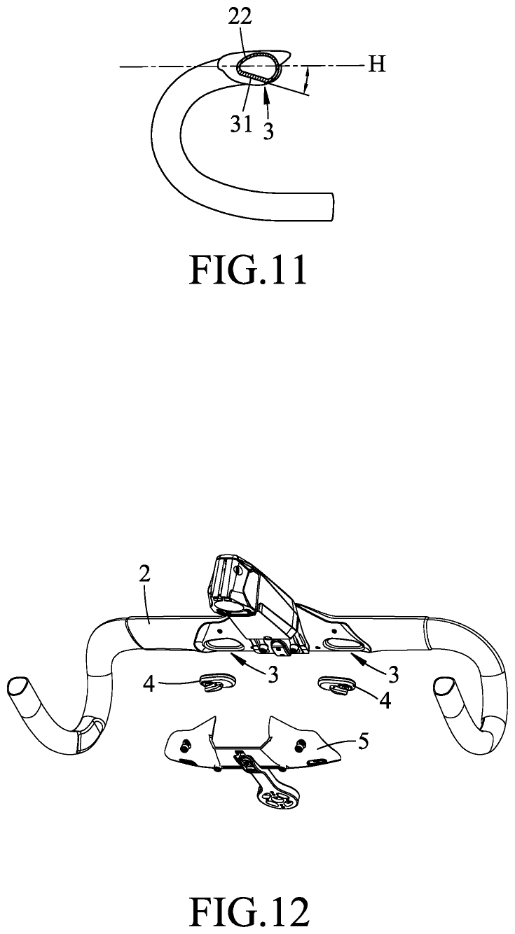

Referring further to FIG. 11, in one embodiment, the mounting surface 31 of the recessed structure 3 that is formed in the right straight portions 22 may be configured as a planar surface. The mounting surface 31 of the recessed structure 3 may be oblique to a horizontal plane (H) in which the right straight portions 22 resides. In one embodiment, the mounting surface 31 of the recessed structure 3 may face downwardly.

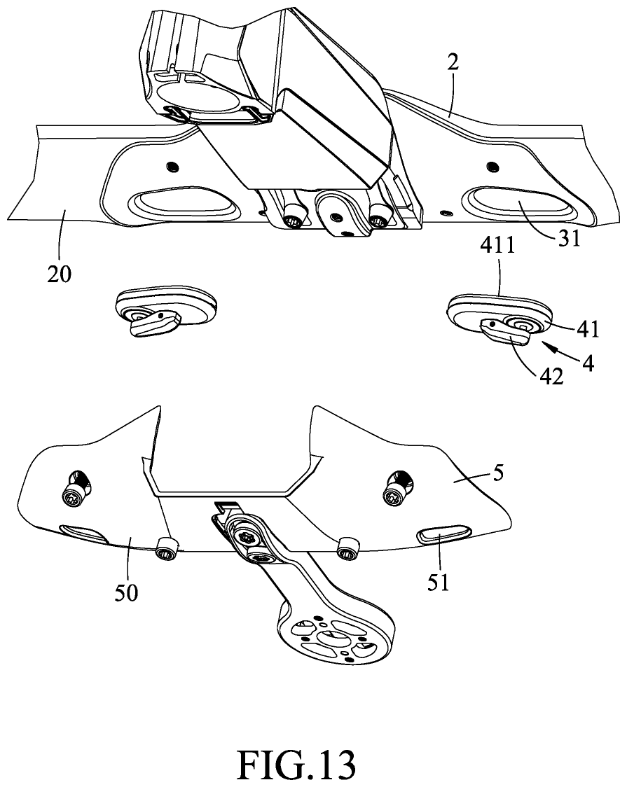

Referring to FIGS. 12 and 13, the bicycle handlebar may further include an integration cover 5 that covers the mounting surface 31 of the recessed structure 3. The integration cover 5 has an outer surface 50 that is opposite to the recessed structure 3 and that cooperates with the outer surface 20 of the handlebar body 2 to form a smooth profile. In one embodiment, the integration cover 5 is mounted to a bottom side of the handlebar body 2.

In one embodiment, the mounting surface 31 of the recessed structure 3 may be shaped to fit the contour of the mounting surface 411 of the casing 41 of the control device 4 that is mounted to the mounting surface 31.

In one embodiment, the integration cover 5 is formed with at least one through hole 51 through which the pushbutton 42 of the control device 4 is accessible.

Referring back to FIG. 2, in one embodiment, the integration cover 5 may permit a bracket 6 to be mounted thereto for supporting a computer 7.

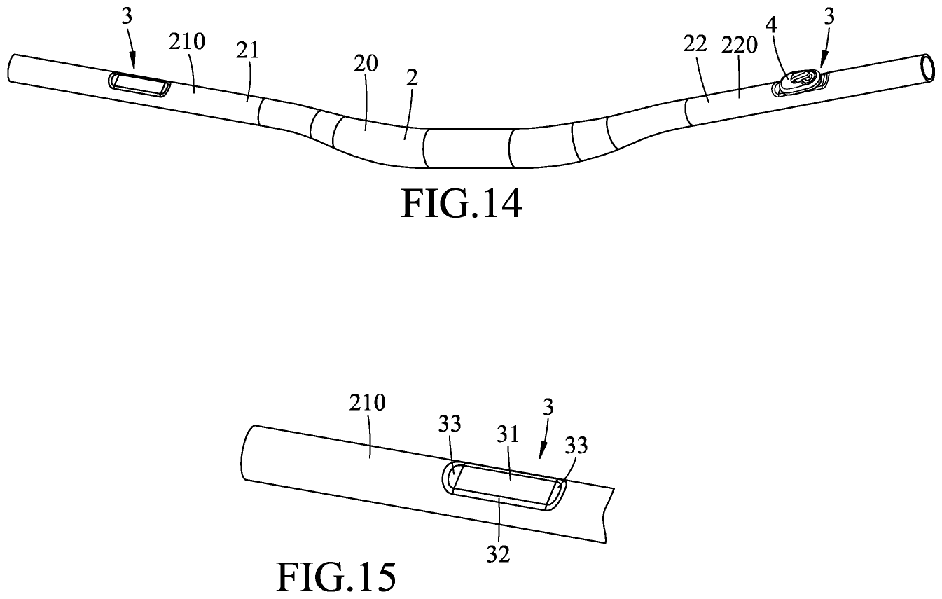

Referring to FIGS. 14 and 15, in one example, the handlebar body 2 has left and right straight portions 21, 22. Each of the left and right straight portions 21, 22 has an outer surface portion 210, 220 that serves as a portion of the outer surface 20 of the handlebar body 2. The mounting surface 31 of the recessed structure 3 is indented from the outer surface portion 210, 220 of one of the left and right straight portions 21, 22 for being mounted with the control device 4. In one embodiment, the recessed structure 3 further has a transition zone 32 that is connected between the mounting surface 31 and the outer surface portion 210 of the left straight portion 21 and that surrounds the mounting surface 31, and two curved surfaces 33 that are respectively connected to two opposite ends of the mounting surface 31. An assembled surface consisting of the mounting surface 31 and the curved surfaces 33 is smooth.

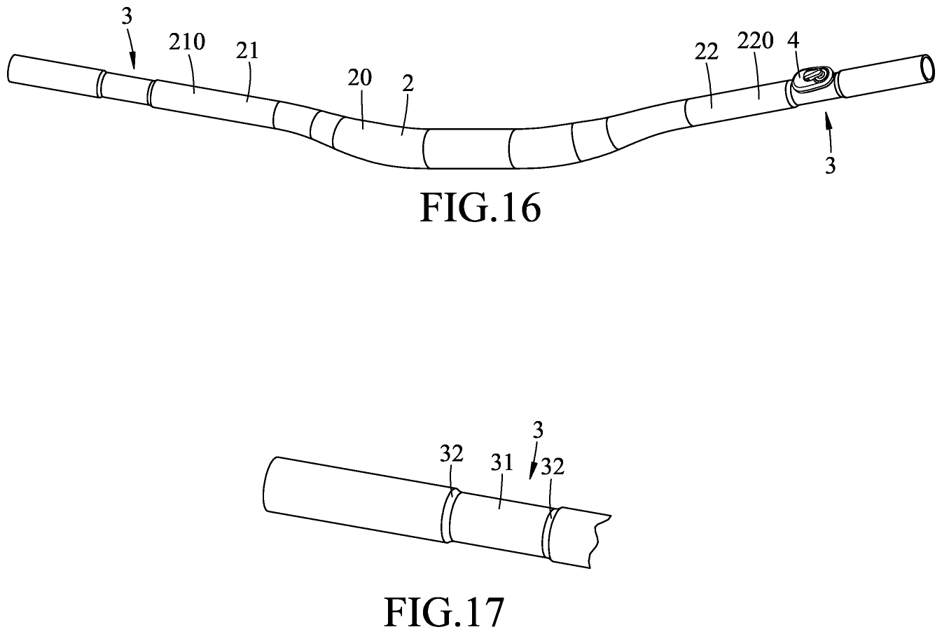

Referring to FIGS. 16 and 17, in one example, the handlebar body 2 has left and right straight portions 21, 22. Each of the left and right straight portions 21, 22 has an outer surface portion 210, 220 that serves as a portion of the outer surface 20 of the handlebar body 2. The mounting surface 31 of the recessed structure 3 is indented from the outer surface portion 210, 220 of one of the left and right straight portions 21, 22 for being mounted with the control device 4. In one embodiment, the recessed structure 3 further has two transition zone 32 that that are respectively connected to two opposite ends of the mounting surface 31. In one embodiment, the mounting surface 31 is configured as a curved surface. In one embodiment, the mounting surface 31 extends about the one of the left and right straight portions 21, 22. For example, the mounting surface 31 may be configured as an annular curved surface.

In practice, the control device 4 may be adhered to the mounting surface 31 by adhesive, double-sided tape or the like, and wrapped by a handlebar tape so as to be attached to the bicycle handlebar.

In summary, by virtue of the mounting surface 31 of the recessed structure 3 that is indented from the outer surface 20 of the handlebar body 2, the control device 4 may be attached to the bicycle handlebar without additional brackets or holders, and the overall appearance of a handlebar assembly consisting of the bicycle handlebar and the control device(s) is smooth, so as to enhance the appearance of a handlebar assembly and to streamline the handlebar assembly. In addition, by virtue of the mounting surface 31 of the recessed structure 3 that is indented from the outer surface 20 of the handlebar body 2, the thickness of a grip portion of the handlebar assembly at which the control device is located is kept in a range of 20 to 50 millimeters, so that the control device is operated with minimized physical effort and discomfort.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A bicycle handlebar adapted to be mounted with at least one control device, comprising:
a handlebar body having an outer surface; and
a recessed structure recessed from the outer surface of the handlebar body, and having a mounting surface that is indented from the outer surface of the handlebar body and that is adapted for the at least one control device to be mounted thereto.

2. The bicycle handlebar as claimed in claim 1, wherein the recessed structure further has a transition zone between the mounting surface and the outer surface of the handlebar body.

3. The bicycle handlebar as claimed in claim 2, wherein the transition zone is configured as a rounded edge that surrounds the mounting surface, a portion of the outer surface of the handlebar body whereat the recessed structure is formed being configured as a curved surface, the radius of curvature of the transition zone being smaller than that of the portion of the outer surface of the handlebar body.

4. The bicycle handlebar as claimed in claim 1, wherein the mounting surface is configured as a planar surface.

5. The bicycle handlebar as claimed in claim 1, wherein the mounting surface is configured as a curved surface.

6. The bicycle handlebar as claimed in claim 1, wherein the mounting surface extends about the handlebar body.

7. The bicycle handlebar as claimed in claim 1, wherein an extent of the mounting surface is adapted to be larger than a dimension of the at least one control device.

8. The bicycle handlebar as claimed in claim 1, wherein the mounting surface is adapted to be shaped to fit the contour of a mounting surface of the at least one control device that is mounted to the mounting surface.

9. The bicycle handlebar as claimed in claim 1, wherein the handlebar body has left and right straight portions respectively located at two opposite sides of a longitudinal vertical plane that has a normal vector extending in a left-right direction, each of the left and right straight portions having an outer surface portion that serves as a portion of the outer surface of the handlebar body, the recessed structure being recessed from the outer surface portion of one of the left and right straight portions of the handlebar body.

10. The bicycle handlebar as claimed in claim 9, wherein the mounting surface of the recessed structure extends along the one of the left and right straight portions of the handlebar body.

11. The bicycle handlebar as claimed in claim 9, wherein the mounting surface of the recessed structure faces downwardly.

12. The bicycle handlebar as claimed in claim 1, wherein the handlebar body has a left straight portion, a right straight portions, a left drop portion and a right drop portion, the left and right straight portions being respectively located at two opposite sides of a longitudinal vertical plane that has a normal vector extending in a left-right direction, the left drop portion being connected to a leftmost end of the left straight portion that is distal from the right straight portion, curling downwardly and extending rearwardly, the right drop portion being connected to a rightmost end of the right straight portion that is distal from the left straight portion, curling downwardly and extending rearwardly, each of the left and right drop portions having an outer surface portion that serves as a portion of the outer surface of the handlebar body, the recessed structure being recessed from the outer surface portion of one of the left and right drop portions of the handlebar body.

13. The bicycle handlebar as claimed in claim 12, wherein the mounting surface of the recessed structure extends along the one of the left and right drop portions of the handlebar body.

14. The bicycle handlebar as claimed in claim 12, wherein the outer surface portion of the left drop portion has an inboard surface portion facing the right drop portion, and the outer surface portion of the right drop portion has an inboard surface portion facing the left drop portion, the recessed structure being recessed from the inboard surface portion of one of the left and right drop portions of the handlebar body, the mounting surface of the recessed structure being indented from the inboard surface portion of the one of the left and right drop portions.

15. The bicycle handlebar as claimed in claim 12, wherein each of the left and right drop portions has an upper portion curling downwardly from the respective one of the left and right straight portions, and a lower portion extending rearwardly from the upper portion, a first reference plane in which the lower portion of the left drop portion resides being oblique to the longitudinal vertical plane, a second reference plane in which the lower portion of the right drop portion resides being oblique to the longitudinal vertical plane.

16. The bicycle handlebar as claimed in claim 12 adapted to be mounted with at least two of the control devices, further comprising at least an additional one of the recessed structures for the other one of the control devices to be mounted thereto, each of the left and right straight portions and the left and right drop portions having an outer surface portion that serves as a portion of the outer surface of the handlebar body, the additional one of the recessed structure being recessed from the outer surface portion of one of the left and right straight portions of the handlebar body.

17. The bicycle handlebar as claimed in claim 1, wherein the recessed structure further has two curved surfaces respectively connected to two opposite ends of the mounting surface, an assembled surface consisting of the mounting surface and the curved surfaces being smooth.

18. The bicycle handlebar as claimed in claim 1, further comprising an integration cover that covers the mounting surface of the recessed structure, the integration cover having an outer surface that is opposite to the recessed structure and that cooperates with the outer surface of the handlebar body to form a smooth profile.

19. The bicycle handlebar as claimed in claim 20, wherein the integration cover is formed with at least one through hole through which the control device is accessible.

20. The bicycle handlebar as claimed in claim 1, wherein a maximum offset distance between the mounting surface and the outer surface of the handlebar body ranges from 1 to 5 millimeters.
